(19) United States
(12) Patent Application Publication
(10) Pub. No.: US 2003/0086013 A1
(43) Pub. Date: May 8, 2003

(54) Compound eye image-taking system and apparatus with the same

(76) Inventor: Michiharu Aratani, Kanagawa (JP)

Correspondence Address: MORGAN & FINNEGAN, L.L.P., 345 PARK AVENUE, NEW YORK, NY, 10154, US

(21) Appl. No.: 10/284,792

(22) Filed: Oct. 31, 2002

(30) Foreign Application Priority Data
Nov. 2, 2001 (JP) 2001-338394

(51) Int. Cl. H04N 5/225

(52) U.S. Cl. 348/335

(57) ABSTRACT

A compound eye image-taking system which can obtain bright parallax images and calculate proper parallax information from these parallax images by a simple and compact construction, is disclosed. This compound eye image-taking system comprises of an optical element array in which a plurality of optical elements. The optical axes of the optical elements are different to each other. Additionally, the system comprises of a image-pickup unit in which a plurality of image-pickup portions which are formed on the same semiconductor substrate and picks up images formed by the optical elements, respectively; and a parallax calculating circuit which calculates parallax information between images picked-up by the image-pickup portions.

### BACKGROUND OF THE INVENTION

1. Field of the Invention

The present invention relates to a compound eye image-taking system to be used for an apparatus such as a digital camera, a videophone, TV game apparatus and the like.

2. Description of the Related Art

Image-taking apparatuses such as a digital video camera and a digital still camera acquire 2D image information of an object by an image-pickup device such as a CCD and a CMOS sensor through a lens unit.

Furthermore, a device for measuring 3D information of an object, a distance to an object, and information on unevenness of an object has also been proposed.

For example, Japanese Laid-open No. 2000-32354 proposes a technique for measuring a distance to a focused object by shifting the focal points of many cameras arranged in parallel little by little in advance.

In addition, Japanese Patent No. 2958458 discloses a technique for acquiring information on a distance to an object based on a stereoscopic image by means of the principle of triangular surveying upon arranging a plurality of cameras.

However, in the technique disclosed in Japanese Laid-open No. 2000-32354, in order to obtain highly accurate distance information, a number of cameras in which the respective focal points are shifted little by little are necessary.

Also, in the technique disclosed in Japanese Patent No. 2958458, a plurality of cameras, fixing members for fixing these cameras, and furthermore, a plurality of image-pickup devices and members for fixing these image-pickup devices are necessary, so that the number of parts is large, resulting in high costs.

On the other hand, Japanese Laid-open No. H09-74572 proposes a stereoscopic camera unit which has been downsized by integrating two image-pickup devices.

However, the stereoscopic camera unit proposed in Japanese Laid-open No. H09-74572 is for only the purpose of acquiring of stereoscopic images, and this publication contains no mention of acquiring of distance information from stereoscopic images. Furthermore, in the stereoscopic camera unit disclosed in the same publication, since two optical systems are provided so as to be movable to obtain desired stereoscopic images, the unit becomes complicated.

Furthermore, in the technique disclosed in Japanese Patent No. 2958458, a plurality of pin holes are made in a single member for use as a so-called pinhole camera, whereby the unit is downsized to be smaller than a unit including a plurality of cameras.

However, the pinhole camera is an optical system which is very dark, so that use conditions are strictly limited.

### SUMMARY OF THE INVENTION

A compound eye image-taking system of the invention comprises of an optical element array in which a plurality of optical elements are integrally formed. The optical axes of the optical elements are different to each other. Additionally the system comprises of an image-pickup unit in which a plurality of image-pickup portions are formed on the same semiconductor substrate and picks up images formed by the optical elements, respectively; and a parallax calculating circuit for calculating parallax information between images picked-up by the plurality of image-pickup portions.

A detailed configuration of the compound eye image-taking system and apparatus with the same of the invention will be apparent from the embodiments, described below.

### BRIEF DESCRIPTION OF THE DRAWINGS

FIG. 1 is a front view of a compound eye image-taking system of Embodiment 1 of the invention, viewed from the objective side.

FIG. 2 is a side sectional view of the compound eye image-taking system of FIG. 1.

FIG. 3 is an exploded perspective view of the compound eye image-taking system of FIG. 1.

FIG. 4 is an explanatory view of an image-pickup unit to be used for the compound eye image-taking system of FIG. 1.

FIG. 5 is a drawing for explaining the concept of parallax and depth in the compound eye image-taking system of FIG. 1.

FIG. 6 is an explanatory view of a videophone apparatus of another embodiment of the invention.

FIG. 7 is an explanatory view of a TV game apparatus of still another embodiment of the invention.

### DETAILED DESCRIPTION OF THE PREFERRED EMBODIMENTS

Hereinafter, preferred embodiments of the invention will be described in detail with reference to the drawings.

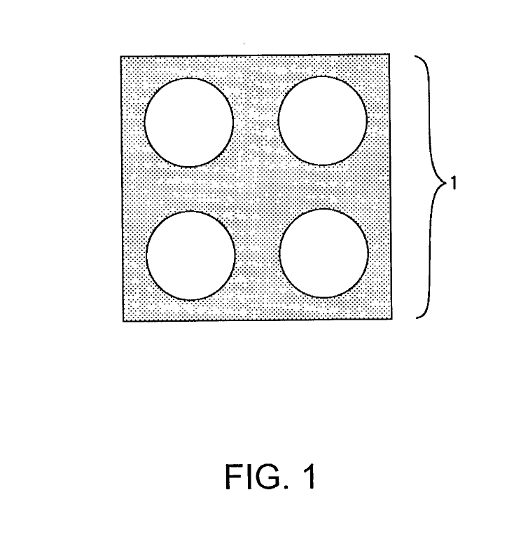

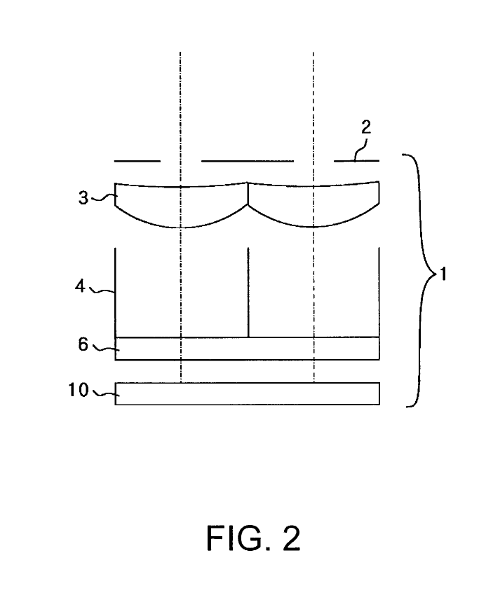

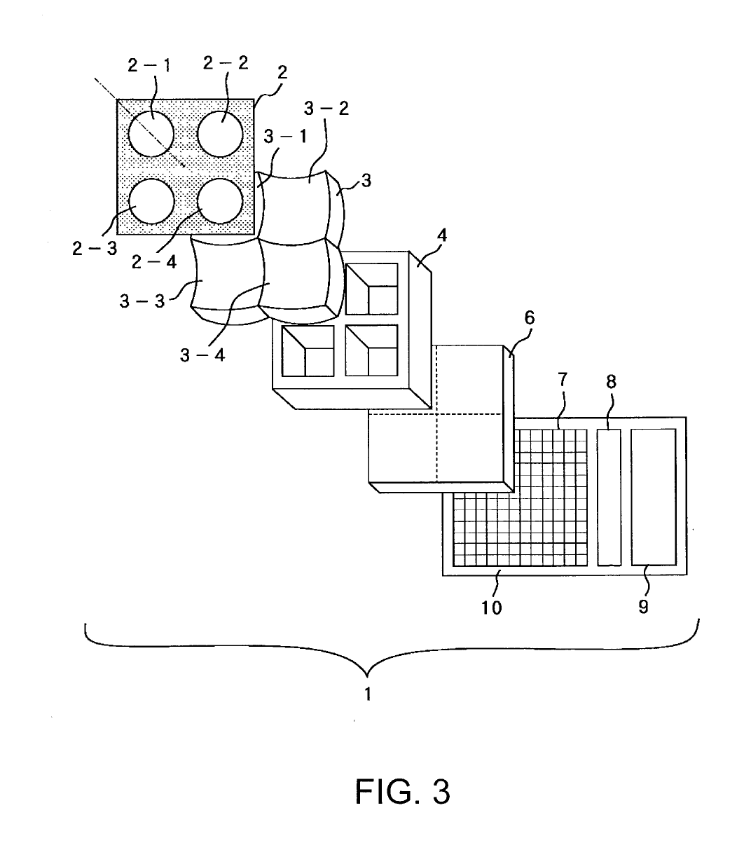

FIG. 1 through FIG. 3 show the construction of a compound eye image-taking system of an embodiment of the invention. FIG. 1 is a front view of the compound eye image-taking system viewed from the object side, and FIG. 2 is a side sectional view of the compound eye image-taking system. FIG. 3 is an exploded perspective view of the compound eye image-taking system.

In these figures, the compound eye image-taking system 1 comprises of, in order from the object side, an aperture-stop member 2, an optical lens (element) array 3, a light shielding block 4, an optical filter 6, and an image-pickup unit 7, which are arranged and constructed as one unit.

Four apertures 2-1, 2-2, 2-3, and 2-4 are made in the aperture-stop member 2, and portions surrounding these apertures block entry of unnecessary outside light into the compound eye image-taking system 1.

The optical lens array 3 consists of four micro lenses 3-1, 3-2, 3-3, and 3-4 which are integrally formed. This optical lens array 3 is formed of optical glass or plastic.

The light shielding block 4 is formed of an nontransparent material, and square pipe-like aperture portions are formed at four locations corresponding to the micro lenses 3-1 through 3-4.

The optical filter 6 is composed of an optical low-pass filter or an infrared ray cutting filter.

Four image-taking optical systems are formed of the four apertures made in the aperture-stop member 2 and four micro lenses of the optical lens array 3.

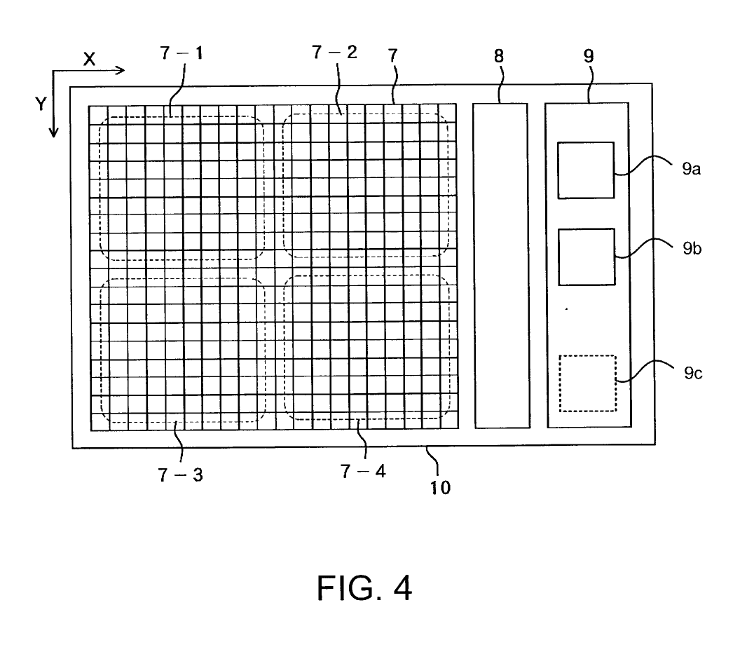

The image-pickup unit 7 has an electronic image-pickup sensor such as a CCD sensor or a CMOS sensor, including a number of image detecting elements (pixels) arrayed as shown in detail in FIG. 4. On the pixels, pixel groups (image-pickup portions) 7-1, 7-2, 7-3 and 7-4 are set on which rays that have passed through the four image-taking optical systems are formed images, respectively.

The abovementioned four image-taking optical systems and the corresponding four pixel groups compose the compound eye image-taking system 1.

The image-pickup unit 7 is formed on a semiconductor substrate 10, and on this semiconductor substrate 10, a drive circuit 8 and a signal processing circuit 9 are also formed. The signal processing circuit 9 includes a parallax calculating circuit 9a and a distance calculating circuit 9b.

Next, image forming action in the compound eye image-taking system 1 of the present embodiment will be described. Among all rays from an image-taken region (a region contains a main object) that is not shown, rays that have passed through the aperture 2-1 of the aperture-stop member 2 is refracted by the micro lens 3-1, and thereafter, passes through the inside of the light shielding block 4 and the optical filter 6 and the image of the rays are formed on the pixel group 7-1 of the image-pickup unit 7.

Furthermore, among all rays from the above-mentioned image-taken region, rays that have passed through the aperture 2-2 of the aperture-stop member 2 is refracted by the micro lens 3-2, and thereafter, passes through the inside of the light shielding block 4 and the optical filter 6 and the image thereof is formed on the pixel group 7-2 of the image-pickup unit 7.

Afterwards, in the same manner, among all rays from the image-taken region, rays that have passed through the apertures 2-3 and 2-4 of the aperture-stop member 2 also form images on the pixel groups 7-3 and 7-4 of the image-pickup unit 7, respectively.

Thus, each of the paths from the apertures of the aperture-stop member 2 to the pixel groups functions as one image-taking system, and these four image-taking systems are collected to compose the compound eye image-taking system 1.

The light shielding block 4 prevents, for example, rays that have entered the aperture 2-1 of the aperture-stop member 2 from reaching the pixel groups other than the pixel group 7-1. Namely, it is prevented that rays that have entered from the respective apertures of the aperture-stop member 2 enter pixel groups other than the pixel groups corresponding to the apertures and cause ghost.

In the present embodiment, the optical axes of the four micro lenses 3-1 through 3-4 are different to each other (substantially in parallel to each other in this embodiment), and all have the same focal length. The four micro lenses 3-1 through 3-4 are disposed adjacent to each other. Furthermore, all the apertures 2-1 through 2-4 of the aperture-stop member 2 have the same aperture diameter. Therefore, these four micro lenses 3-1 through 3-4 form images of an object in roughly the same image-taken region on the respective corresponding pixel groups.

Furthermore, the compound eye image-taking system 1 of the present embodiment is adjusted so that the image of an object at an optional distance is most clearly formed by the image-pickup unit 7. Focusing of the compound eye image-taking system 1 is carried out by adjusting the relative distance between the optical lens array 3 and the image-pickup unit 7 by a drive mechanism that is not shown.

In the compound eye image-taking system 1 of the present embodiment, all pixel groups 7-1 through 7-4 are formed on the same plane (on the single substrate 10). Therefore, when assembling the compound eye image-taking system 1, it becomes unnecessary to carry out wiring for the pixel groups 7-1 through 7-4 or align them, the assembly process can be simplified, and focusing of the four image-taking systems can be simultaneously carried out according to the abovementioned focusing.

Furthermore, as mentioned above, the optical lens array 3 includes four micro lenses 3-1 through 3-4 integrated with each other, so that the number of parts for the compound eye image-taking system 1 can be reduced, and positional adjustments of the respective micro lenses during assembly of the compound eye image-taking system 1 becomes unnecessary. Furthermore, in assembly, it is required to hold only the optical lens array 3, and a mechanism for holding the respective micro lenses is unnecessary, so that the construction of the assembly apparatus can be simplified and the assembling process can be simplified.

Next, parallax influence generated at the compound eye image-taking system 1 of the present embodiment will be described. As aforementioned, in the compound eye image-taking system 1 of the present embodiment, the optical axes of the respective micro lenses 3-1 through 3-4 are set substantially parallel to each other, and the micro lenses are set so as to have the same focal length, so that roughly the same object image is formed on the respective pixel groups.

However, since the respective micro lenses are separated by finite distances from each other, slightly different object images are formed on the respective pixel groups due to parallax influence.

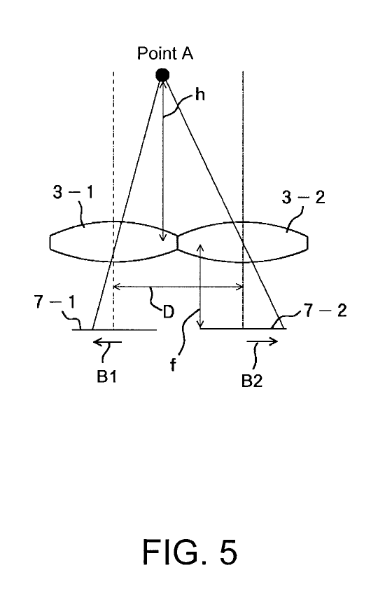

FIG. 5 shows the image forming relationship in the present embodiment. An image at the point A that is at a distance h from the optical lens array 3 is formed on the pixel group 7-1 by the micro lens 3-1 and formed on the pixel group 7-2 by the micro lens 3-2. Herein, the micro lenses 3-1 and 3-2 are disposed so that the interval between the optical axes thereof is D.

Hereinafter, a description will be given when the direction of the interval between the micro lenses is defined as a base line direction, and the interval between the micro lenses is defined as a base length.

On the pixel group 7-1, the image of point A is formed at a distance B1 in the base line direction from the optical axis of the micro lens 3-1, and on the pixel group 7-2, the image of point A is formed at a distance B2 in the base line direction from the optical axis of the micro lens 3-2. Therefore, the point A image picked-up by the pixel group 7-1 and the point A image picked-up by the pixel group 7-2 deviate from each other by B1+B2 in the base line direction.

Therefore, by comparing the image picked-up by the pixel group 7-1 and the image picked-up by the pixel group 7-2, a parallax amount, that is, a point A deviation amount of B1+B2 can be determined. The distance h to the point A can be determined by the following equation (1), provided that f shows the focal length of the micro lens 3-1 and the micro lens 3-2.

$$h = \frac{fD}{{B}_{1} + {B}_{2}} \qquad Equation ( 1 )$$

Next, signal processing in the compound eye image-taking system 1 of the present embodiment will be described. The drive circuit 8 drives the image-pickup unit 7 and carries out an exposure operation (charge storage) of the respective pixel groups, and then carries out a reading-out operation of luminance signals of the respective pixels.

Herein, image coordinates (x, y) are used. On the image coordinates (x, y), the upper left corners of the respective pixel groups are defined as origins, and the horizontal direction is defined as an X axis, and the vertical direction is defined as a Y axis. Furthermore, a description will be given when the luminance at the pixel coordinates (x, y) of the pixel group 7-1, which is readout by the drive circuit 8, is defined as F1(x, y), and likewise, the luminance of the pixel group 7-2 is defined as F2(x, y), the luminance of the pixel group 7-3 is defined as F3(x, y), and the luminance of the pixel group 7-4 is defined as F4(x, Y).

The parallax calculating circuit 9a in the signal processing circuit 9 calculates values of parallax in each pixel group from the image signals readout by the drive circuit 8. A parallax amount at optional coordinates (x, y) in the pixel group 7-1 can be determined by searching for a luminance of the pixel group 7-2 most similar to the luminance F1(x, y) of the pixel group 7-1 at the optional coordinates (x, y) and referring to the interval between the coordinates of the pixel showing this most similar luminance in the pixel group 7-2 and the optional coordinates (x, y) in the pixel group 7-1.

However, since it is generally difficult to search for a pixel most similar to an optional pixel, pixels near the image coordinates (x, y) are also used to search a similar pixel by means of a method called block matching.

For example, block matching in a case where a block size is 3 is described herein. Luminance values of a total of three pixels including a pixel at optional coordinates (x, y) in the pixel group 7-1 and two front and rear pixels at (x−1, y) and (x+1, y) are F1(x, y), F1(x−1, y), and F1(x+1, y), respectively.

On the other hand, the luminance values of the corresponding pixels in the pixel group 7-2 deviating by k from the optional coordinates (x, y) in the X direction are F2(x+k, y), F2(x+k−1, y), and F2(x+k+1, y), respectively.

In this case, the similarity E to the pixel at the coordinates (x, y) in the pixel group 7-1 is defined by the following equation (2):

$$\begin{matrix}E = [ {F}_{1} ( x , y ) - {F}_{2} ( x + k , y ) ] + [ {F}_{1} ( x - 1 , y ) - \\ {F}_{2} ( x + k - 1 , y ) ] + [ {F}_{1} ( x + 1 , y ) - \\ {F}_{2} ( x + k + 1 , y ) ] \\ = {\sum }_{i = - 1}^{1} [ {F}_{1} ( x + j , y ) - {F}_{2} ( x + k + j , y ) ]\end{matrix} \qquad Equation ( 2 )$$

In this equation (2), the value of the abovementioned similarity E is calculated by successively changing the value of k, and k which leads to the smallest similarity E causes parallax at the coordinates (x, y) in the pixel group 7-1.

Furthermore, as mentioned above, parallax occurs in the base line direction between the micro lenses. Therefore, when calculating parallax of pixel groups 7-1 and 7-2, parallax occurs in the direction between the micro lens 3-1 and the micro lens 3-2, that is, the X direction.

Therefore, in a case of searching for pixels similar to each other between the pixel groups 7-1 and 7-2, a search may be carried out in the X direction.

When calculating parallax of a pixel at coordinates (x, y) in the pixel group 7-1 with respect to the pixel group 7-2, the signal processing circuit 9 stores a luminance value of a pixel on the x-th line in the pixel group 7-1 in a buffer, and likewise, stores a luminance value of a pixel on the x-th line in the pixel group 7-2 in the buffer.

Thereafter, the similarity is calculated while successively changing the value of k, and a value of k which leads to the smallest similarity is determined as parallax amount at the coordinates (x, y).

Next, the distance calculating circuit 9b in the signal processing circuit 9 calculates a distance h to an object from the parallax amount by means of the following equation (3). In this equation, D shows the interval (base length) between the optical axes of the micro lens 3-1 and the micro lens 3-2, f shows the focal length of the micro lenses, and d shows the interval of the pixels.

h=fD/kd (3)

Afterwards, similar processing is carried out for all pixels in the pixel group 7-1, whereby distances to an object to be imaged by the pixel group 7-1 can also be detected for each pixel. Furthermore, since the distances can be detected for each pixel, the shape of the object to be imaged can be measured.

The compound eye image-taking system 1 of the present embodiment is constructed so as to include four micro lenses and four pixel groups, as in a distance to the object to be taken images by the pixel groups 7-1 and 7-2 is measured based on parallax between the pixel groups 7-1 and 7-2, similar processing can also be carried out for a combination of the pixel groups 7-1 and 7-3.

Likewise, for a combination of the pixel group 7-1 and the pixel group 7-4 and a combination of the pixel group 7-2 and the pixel group 7-3, similar processing can also be carried out.

As mentioned above, since parallax occurs along the base line direction between the micro lenses, in the combination of the pixel groups 7-1 and 7-3, parallax occurs in the Y direction of FIG. 4, and in the combination of the pixel groups 7-1 and 7-4 and the combination of the pixel groups 7-2 and 7-3, parallax occurs diagonally.

It is thus possible to determine the distances based on a plurality of combinations of the pixel groups, so that reliability in measurement of object distances can be improved by comparing these.

In the compound eye image-taking system 1 of the present embodiment, as mentioned above, the signal processing circuit 9 calculates a parallax amount of the pixel at the coordinates (x, y) in the pixel group 7-1 with respect to the pixel group 7-2 and calculates an object distance based on the parallax amount, and then, stores the object distance and the minimum value of the similarity calculated when calculating parallax in the buffer together with the luminance value F1(x, y) of the coordinates (x, y).

Next, by similar processing, a parallax amount of a pixel at coordinates (x, y) in the pixel group 7-1 with respect to the pixel group 7-3 and an object distance are calculated. When the minimum value of the similarity calculated at this coordinates is smaller than that previously stored in the buffer, the newly calculated object distance and the newly calculated similarity minimum value are renewedly stored in the buffer.

Next, similar processing is carried out for the pixel groups 7-1 and 7-4. By such processing, an object distance with the smallest similarity, that is, a most reliable object distance can be obtained.

Generally, searching for similar pixels by means of the abovementioned block matching easily changes in accuracy between a case where an object has a vertical edge and a case where an object has a horizontal edge, however, as in the compound eye image-taking system 1 of the present embodiment, by using measured values based on a plurality of base lines, object distances that are stable regardless of object kinds can be obtained.

Furthermore, in the present embodiment, a value with the smallest similarity among a plurality of measured distances is defined as an object distance, however, it is also possible that a plurality of measured distances are averaged, and by this method, improvement in reliability and accuracy can also be expected.

In the compound eye image-taking system 1 of the present embodiment, four pixel groups 7-1 through 7-4, the drive circuit 8, and the signal processing circuit 9 are all formed on the same semiconductor substrate 10. By such a construction, the number of parts for the compound eye image-taking system 1 can be reduced, and the process such as wiring in assembly of the compound eye image-taking system 1 can be simplified.

Furthermore, by forming the image-pickup unit 7, the drive circuit 8, and the signal processing circuit 9 on the same semiconductor substrate 10, the image-pickup unit 7, the drive circuit 8, and the signal processing circuit 9 can be disposed in close proximity to each other. Thereby, wiring between the image-pickup unit 7 and the drive circuit 8 and wiring between the drive circuit 8 and the signal processing circuit 9 become easier, reliability in data exchange between the image-pickup unit 7 and the drive circuit 8 and between the drive circuit 8 and the signal processing circuit 9 can be improved, and high-speed and large-scale data transmission becomes possible.

In the present embodiment, a case where four micro lenses and four pixel groups compose the compound eye image-taking system 1 is described, however, at least two micro lenses and two pixel groups are required to measure distance information of an image-taken region. Furthermore, it is also possible that micro lenses and pixel groups of more than four compose the compound eye image-taking system. By increasing the numbers of micro lenses and pixel groups, distance measurement using micro lenses with various base lengths and various base line directions becomes possible, improvement in reliability and accuracy of distance measuring results can be expected.

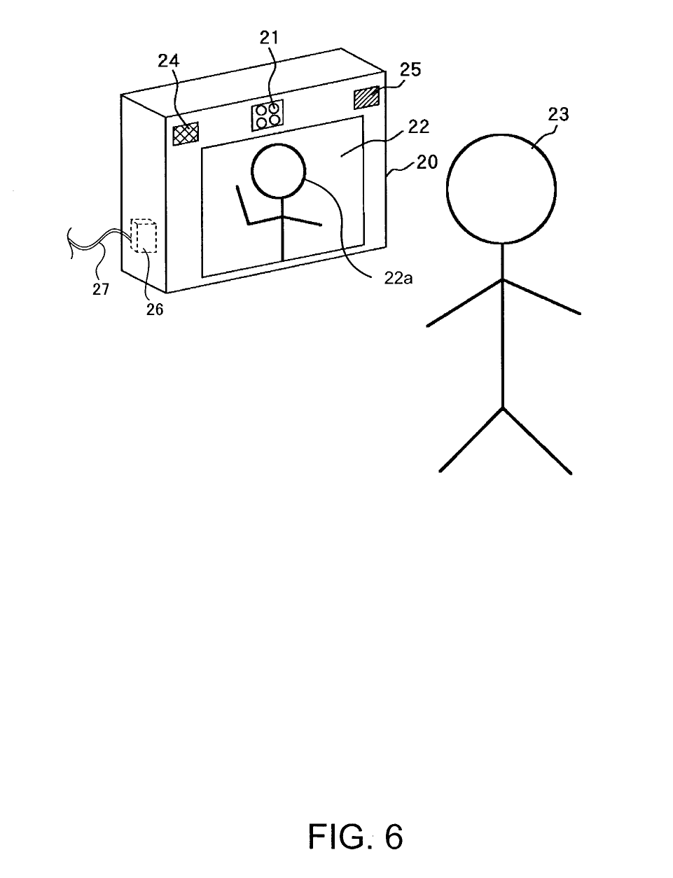

FIG. 6 shows a construction of a videophone apparatus of another embodiment of the present invention. In this embodiment, the compound eye image-taking system 21 that is basically the same as described in the abovementioned embodiment is installed on a videophone apparatus 20 so as to face a calling person 23.

On a display device 22 such as a liquid crystal monitor, an image (moving image or intermittently changing still image) 22a of an opposite calling person sent from another videophone apparatus (not shown) are displayed. A call with the opposite calling person is made via a microphone 24 and a speaker 25.

Images taken by the compound eye image-taking system 21 are displayed on the display device on the other videophone apparatus (not shown) at the opposite calling person side via a communication line 27 from an output circuit 26 that is provided in the videophone 20.

As abovementioned, the compound eye image-taking system 21 can measure distances to an object, in this embodiment, a region distinguishing circuit 9c shown by a dotted line in FIG. 4 is added in the signal processing circuit 9 of the compound eye image-taking system 21 is constructed so as to output image signals only for pixels whose object distances are 2m(meters) or less, that is, distinguish and extract only main object images.

Thereby, for example, images of the calling person (main object) 23 at a distance of lm from the compound eye image-taking system 21 are displayed on the display device at the opposite calling person side, however, images of the background and others at a distance of 3 m from the compound eye image-taking system 21 are not displayed on the display device at the opposite calling person side.

By employing such a construction, communications of images that do not need to be transmitted other than images of the calling person 23 can be avoided, and it becomes possible to increase the transmission speed and protect privacy in use of videophones.

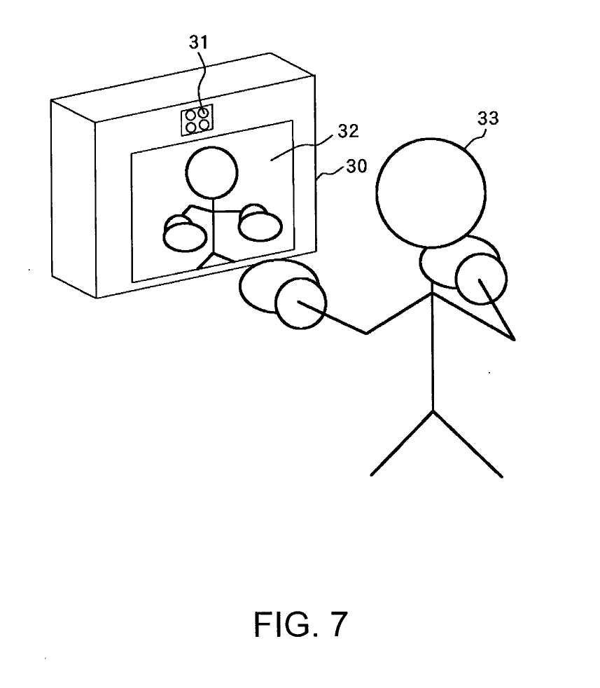

FIG. 7 shows a construction of a TV game apparatus of still another embodiment of the present invention. In this figure, on a TV game apparatus 30, the compound eye image-taking system 31 that is described in the abovementioned embodiment of FIG. 1 through FIG. 5 is installed so as to face a player 33.

On a display device 32 such as a liquid crystal monitor, a game screen is displayed. In response to the screen displayed on the display device 32, the player 33 motions, for example, like he/she is boxing, to bring his/her fists back and forth, or like dancing, move his/her hands and feet from front to back and from side to side.

As mentioned above, the compound eye image-taking system 31 can measure distances to an object and the shape of an object, so that back and forth movements of the player 33's fists can be detected, and this makes it possible for the player 33 to play boxing game with an opponent on the screen.

The compound eye image-taking system of the invention described in the embodiment of FIG. 1 through FIG. 5 can also be used for various apparatuses other than the apparatuses described in FIG. 6 and FIG. 7.

As described above, according to the compound eye image-taking system described in FIG. 1 through FIG. 5, bright parallax images can be obtained even by simple and compact construction. Furthermore, proper parallax information can be calculated from these parallax images.

Furthermore, since a plurality of image-pickup portions are formed on one semiconductor substrate in the image-pickup unit, positional adjustments of the respective image-pickup portions can be eliminated, and when focusing, the image-pickup portions and the optical element array which are formed as one unit can be relatively driven. Therefore, the focusing mechanism can be simplified.

Furthermore, by forming a parallax calculating circuit on the semiconductor substrate on which the plurality of image-pickup portions are formed, the compound eye image-taking system including up to the parallax calculating circuit can be constructed as one unit, whereby simplification of assembly and wiring and compactness of an apparatus in which this compound eye image-taking system is mounted can be achieved.

Furthermore, a region distinguishing circuit for distinguishing a specific region in which a main object has been imaged in the entire image-taken region based on calculated parallax information is provided, and a distance calculating circuit for calculating distances to an object based on parallax information is provided, whereby it becomes possible to extract (output) only image signals in a specific region (for example, a region of the main object) and detect distances to an object and the shape of the object.

Furthermore, a region distinguishing circuit and a distance calculating circuit are formed on the semiconductor substrate on which image-pickup portions have been formed together with a parallax calculating circuit, whereby the assembly process of the compound eye image-taking system including the abovementioned circuits can be simplified, and work for wiring between these circuits can be eliminated. Moreover, since data exchange between the image-pickup portions and the circuits and between the circuits can be made at high speed, the speed of processing such as image-taking and distance measurement can be increased.

In the abovementioned embodiments, the optical axes of the micro lenses of the optical lens array are substantially in parallel to each other. However, the optical axes may widen towards the object side, or converge into the object side.

While preferred embodiments have been described, it is to be understood that modification and variation of the present invention may be made without departing from the sprit or scope of the following claims.

What is claimed is:

1. A compound eye image-taking system comprising:
an optical element array in which a plurality of optical elements are integrally formed, the optical axes of said optical elements are different to each other;
an image-pickup unit in which a plurality of image-pickup portions are formed on the same semiconductor substrate and picks up images formed by said optical elements, respectively; and
a parallax calculating circuit which calculates parallax information between images picked-up by said image-pickup portions.

2. The compound eye image-taking system according to claim 1, wherein
said parallax calculating circuit is formed on said semiconductor substrate.

3. The compound eye image-taking system according to claim 1, further comprising:
a region distinguishing circuit which distinguishes a specific region in which a main object image has been picked-up in the entire image-taken region.

4. The compound eye image-taking system according to claim 3, wherein
said region distinguishing circuit is formed on said semiconductor substrate.

5. The compound eye image-taking system according to claim 3, wherein
the system outputs only image information in the specific region that is distinguished by said region distinguishing circuit.

6. The compound eye image-taking system according to claim 1, further comprising:
a distance calculating circuit which calculates a distance to an object based on parallax information calculated by said parallax calculating circuit.

7. The compound eye image-taking system according to claim 6, wherein
said distance calculating circuit is formed on said semiconductor substrate.

8. An apparatus with a compound eye image-taking system comprising:
the compound eye image-taking system according to claim 1; and
a display device which displays images picked-up by said compound eye image-taking system.

9. An apparatus with a compound eye image-taking system comprising:
the compound eye image-taking system according to claim 1; and
an output circuit which outputs information on images picked-up by said compound eye image-taking system.
